(19) United States
(12) Patent Application Publication
(10) Pub. No.: US 2026/0081633 A1
(43) Pub. Date: Mar. 19, 2026

(54) RECEIVING MODULE, OPERATION METHOD THEREOF AND USER EQUIPMENT USING THE SAME

(71) Applicant: MEDIATEK INC., Hsinchu City (TW)

(72) Inventors: Hsiao-Wei Chen, Hsinchu City (TW); Chao-Wei Wang, Hsinchu City (TW); Li-Han Hung, Hsinchu City (TW); Jen-Yang Liu, Hsinchu City (TW)

(21) Appl. No.: 19/089,108

(22) Filed: Mar. 25, 2025

Related U.S. Application Data
(60) Provisional application No. 63/694,284, filed on Sep. 13, 2024.

(51) Int. Cl. H04B 1/16; H04W 72/0453

(52) U.S. Cl. CPC H04B 1/16; H04W 72/0453

(57) ABSTRACT

A receiving module, an operation method thereof and a user equipment using the same are provided. The receiving module comprises a plurality of IF paths associated with a plurality of RF paths, at least one multiplexer (MUX) and at least one power detector (PD). Each of the IF paths comprises a transimpedance amplifier (TIA) and a low-pass filter (LPF). The LPF is coupled to an output of the TIA. The at least one multiplexer is coupled to the IF paths. The at least one PD is selectively coupled to at least two IF paths of the IF paths through the at least one multiplexer, to alternately detect a signal strength of a corresponding node between the TIA and the LPF in a corresponding IF path. The at least two IF paths are associated with at least two RF paths of the RF paths with the same carrier frequency.

This application claims the benefit of U.S. Provisional application Ser. No. 63/694,284, filed Sep. 13, 2024, the disclosure of which is incorporated by reference herein in its entirety.

### TECHNICAL FIELD

The disclosure relates in general to a circuit, an operation method thereof and an electric device using the same, and more particularly to a receiving module, an operation method thereof and a user equipment using the same.

### BACKGROUND

In the wireless communication technology, Automatic gain control (AGC) could be used to improve the transmission efficiency. The AGC is a closed-loop feedback regulating circuit in an amplifier or chain of amplifiers, the purpose of which is to maintain a suitable signal amplitude at its output, despite variation of the signal amplitude at the input.

For executing the AGC, the power on the signal receiving path could be detected to determine the suitable gain adjustment.

### SUMMARY

The disclosure is directed to a receiving module, an operation method thereof and a user equipment using the same. Several IF paths share the same power detector, so the number of the power detector(s) could be reduced and the chip area could be reduced.

According to one embodiment, a receiving module is provided. The receiving module comprises a plurality of IF paths associated with a plurality of RF paths, at least one multiplexer (MUX) and at least one power detector (PD). Each of the IF paths comprises a transimpedance amplifier (TIA) and a low-pass filter (LPF). The low-pass filter is coupled to an output of the transimpedance amplifier. The at least one multiplexer is coupled to the IF paths. One of the at least one power detector is selectively coupled to at least two IF paths of the IF paths through the at least one multiplexer, to alternately detect a signal strength of a corresponding node between the TIA and the LPF in a corresponding IF path. The at least two IF paths are associated with at least two RF paths of the plurality of RF paths with the same carrier frequency.

Based on the receiving module described above, the receiving module further comprises at least one frequency synthesizer. The frequency synthesizer is coupled to the RF paths. Each of the at least one frequency synthesizer is associated with a corresponding carrier frequency.

Based on the receiving module described above, the number of the at least one PD is twice the number of the at least one frequency synthesizer.

Based on the receiving module described above, the number of the at least one PD is equal to the number of the at least one frequency synthesizer.

Based on the receiving module described above, all of the at least two IF paths are In-phase paths; or all of the at least two IF paths are Quadrature paths.

Based on the receiving module described above, each of the at least two IF paths comprises an In-phase path and a Quadrature path.

Based on the receiving module described above, each of the RF paths comprises a low noise amplifier (LNA) and a mixer. The LNA is configured to amply a corresponding RF signal. The mixer is coupled to the LNA and configured to perform down-conversion on an output signal of the LNA to provide a down-converted signal to corresponding IF paths. An amplitude of the LNA in the corresponding RF path is adjusted according to a signal strength of the corresponding IF paths.

According to another embodiment, an operation method of a receiving module is provided. The receiving module comprises at least one power detector (PD) selectively coupled to at least two IF paths through at least one multiplexer, to alternately detect a signal strength of a corresponding node in a corresponding IF path. The at least two IF paths are associated with at least two RF paths with the same carrier frequency. The operation method of the receiving module comprises the following steps. A switch signal is provided to a multiplexer (MUX). A signal strength of a signal outputted from a transimpedance amplifier on one of the IF paths is detected by the power detector to obtain a detection result. A flag is recorded according to the detection result of the power detector for use in automatic gain control.

Based on the operation method described above, all of the at least two IF paths are In-phase paths; or all of the at least two IF paths are Quadrature paths.

Based on the operation method described above, at least one frequency synthesizer is coupled to the RF paths, and each of the at least one frequency synthesizer is associated with a corresponding carrier frequency.

Based on the operation method described above, the number of the at least one PD is twice the number of the at least one frequency synthesizer.

Based on the operation method described above, the number of the at least one PD is equal to the number of the at least one frequency synthesizer.

Based on the operation method described above, all of the at least two IF paths are In-phase paths; or all of the at least two IF paths are Quadrature paths.

According to an alternative embodiment, a user equipment (UE) is provided. The user equipment comprises a receiving module. The receiving module comprises a plurality of IF paths associated with a plurality of RF paths, at least one multiplexer (MUX) and at least one power detector (PD). Each of the IF paths comprises a transimpedance amplifier (TIA) and a low-pass filter (LPF). The low-pass filter is coupled to an output of the transimpedance amplifier. The at least one multiplexer is coupled to the IF paths. One of the at least one power detector is selectively coupled to the at least two IF paths of the IF paths through the at least one multiplexer, to alternately detect a signal strength of a corresponding node between the TIA and the LPF in a corresponding IF path. The at least two IF paths are associated with at least two RF paths of the plurality of RF paths with the same carrier frequency.

Based on the user equipment described above, the user equipment further comprises at least one frequency synthesizer. The frequency synthesizer is coupled to the RF paths, wherein each of the at least one frequency synthesizer is associated with a corresponding carrier frequency.

Based on the user equipment described above, the number of the at least one PD is twice the number of the at least one frequency synthesizer.

Based on the user equipment described above, the number of the at least one PD is equal to the number of the at least one frequency synthesizer.

Based on the user equipment described above, all of the at least two IF paths are In-phase paths; or all of the at least two IF paths are Quadrature paths.

Based on the user equipment described above, each of the at least two IF paths comprises an In-phase path and a Quadrature path.

Based on the user equipment described above, each of the RF paths comprises a low noise amplifier (LNA) and a mixer. The low noise amplifier (LNA) is configured to amply a corresponding RF signal. The mixer is coupled to the LNA and configured to perform down-conversion on an output signal of the LNA to provide a down-converted signal to corresponding IF paths. An amplitude of the LNA in the corresponding RF path is adjusted according to a signal strength of the corresponding IF paths.

### BRIEF DESCRIPTION OF THE DRAWINGS

FIG. 1 shows a plurality of radio frequency (RF) paths and a plurality of IF paths in a receiving module according to one embodiment of the present disclosure.

FIG. 2 shows the signal power on the IF path according to one embodiment of the present disclosure.

FIG. 3 shows a plurality of IF paths in the receiving module according to one embodiment of the present disclosure.

FIG. 4 shows the switching for the power detector according to one embodiment of the present disclosure.

FIG. 5 shows the switching for the power detectors according to another embodiment of the present disclosure.

FIG. 6 shows the detection in one slot according to one embodiment of the present disclosure.

FIG. 7 shows a flowchart of an operation method of the receiving module according to one embodiment of the present disclosure.

FIG. 8 illustrates the steps in the FIG. 7 according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

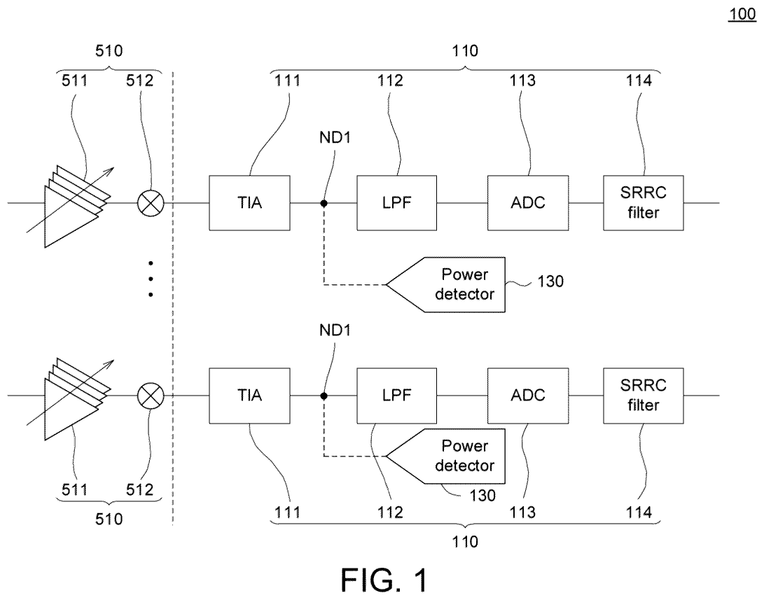

Please refer to FIG. 1, which shows a plurality of radio frequency (RF) paths 510 and a plurality of intermediate frequency (IF) paths 110 in a receiving module 100 according to one embodiment of the present disclosure. For example, the receiving module 100 may be arranged in the user equipment (UE). It should be noted that after an RF signal is converted to an IF signal, it is usually divided into I (in-phase) and Q (quadrature) paths for IQ demodulation. In other words, each IF path 110 may comprise the I path and the Q path. However, for the sake of simplicity, only one path of the I path and the Q path is shown for illustrative purposes. The receiving module 100 is, for example, a transceiver (XCVR), a modulator-demodulator (MODEM) or a combination thereof. The RF path 510 comprises, for example, a low noise amplifier (LNA) 511 and a mixer 512. The low-noise amplifier 511 is an electronic component that can amplify a very low-power signal without significantly degrading its signal-to-noise ratio (SNR). The mixer 512 is a frequency translating device that can convert input signals from one frequency to another by mixing these signals with another signal of known frequency (for example, a carrier frequency). In the embodiment, the mixer 512 is a downconverter used to convert an RF signal to an IF signal, specifically to a baseband (BB) signal. In one example, the IF path 110 can also be called as a BB path.

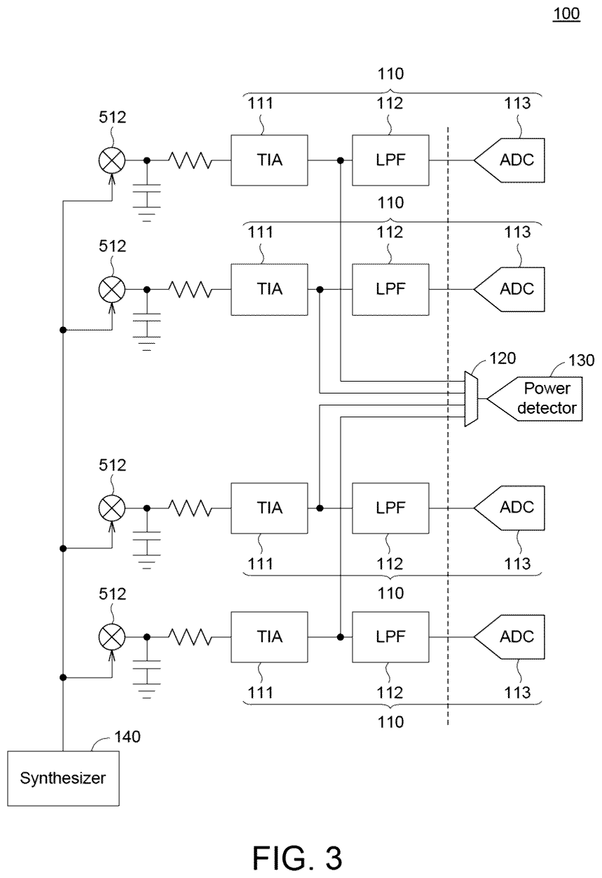

As shown by FIG. 1, the IF path 110 comprises, for example, a transimpedance amplifier (TIA) 111, a low-pass filter (LPF) 112, an analog-to-digital converter (ADC) 113 and a square root raised cosine (SRRC) filter 114. It should be noted that FIG. 1 is merely an exemplary description, and the present disclosure is not limited to this. For example, additional structures may be comprised beyond the components shown in the FIG. 1. For example, a filter may be additionally provided between the mixer 512 and the TIA 111. In one example, the additional filter is shown in FIG. 3 as a capacitor and resistor.

The transimpedance amplifier 111 is a current to voltage converter, almost exclusively implemented with one or more operational amplifiers. In one embodiment, the transimpedance amplifier 111 has filtering capability.

The low-pass filter 112 may be, for example, a BiQuad filter or a programmable gain amplifier with integrated filter. The low-pass filter 112 is an analog baseband filter and has filtering capability.

The analog-to-digital converter 113 is used to convert an analog signal into a digital signal. The square root raised cosine filter 114 is used to perform matched filtering. The square root raised cosine filter 114 helps in constraining the occupied bandwidth of the waveform without introducing inter-symbol interference (ISI). The square root raised cosine filter 114 is a digital baseband (DBB) filter.

In a CA (carrier aggregation)-rich product (product supporting lots of carrier aggregation cases, such as MIMO), each of the IF paths 110 is needed to detect the signal power for realizing the automatic gain control (AGC). For example, each of the I path and Q path of the IF paths 110 is needed to be coupled to a corresponding power detector (PD) 130 at a node ND1, respectively. However, if every I path and Q path couple to one respective power detector 130 respectively, those numerous power detectors 130 would occupy large space in the chip. In the present disclosure, at least two IF paths 110 associated with at least two RF paths with the same carrier frequency could share the same power detector 130, so the number of the power detector(s) 130 could be reduced and the chip area could be reduced.

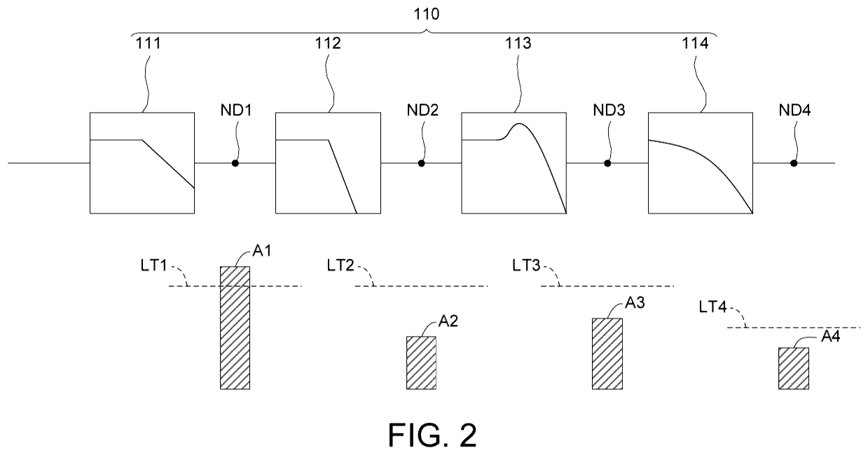

Please refer to FIG. 2, which shows the signal power on the IF path 110 according to one embodiment of the present disclosure. At the node ND1, the amplitude A1 of the signal outputted from the transimpedance amplifier 111 should be controlled to be lower the limit level LT1 (or between two corresponding limit levels). At the node ND2, the amplitude A2 of the signal outputted from the low-pass filter 112 should be controlled to be lower the limit level LT2 (or between two corresponding limit levels). At the node ND3, the amplitude A3 of the signal outputted from the analog-to-digital converter 113 should be controlled to be lower the limit level LT3 (or between two corresponding limit levels). At the node ND4, the amplitude A4 of the signal outputted from the square root raised cosine filter 114 should be controlled to be lower the limit level LT4 (or between two corresponding limit levels). That is, the signal at the node ND4 may have been partially blocked by the transimpedance amplifier 111, the low-pass filter 112, the signal transfer function (STF) of the analog-to-digital converter 113 and the square root raised cosine filter 114. Hence, even if the amplitude A4 at the node ND4 is lower than the limit level LT4 (or between the two corresponding limit levels), it is not sure that the amplitude A3 (or A2, A1) at the node ND3 (or ND2, ND1) is also lower the limit level LT3 (or LT2, LT1) (or between the two corresponding limit levels) or not. To control the amplitudes A1, A2, A3, and A4 of the signal on the IF path 110, the node ND1, which is between TIA 111 and LPF 112, is the best position for power detection.

Please refer to FIG. 3, which shows a plurality of IF paths 110 in the receiving module 100 according to one embodiment of the present disclosure. The receiving module 100 comprises, for example, the IF paths 110, a multiplexer (MUX) 120, the power detector (PD) 130, and the synthesizer (i.e., frequency synthesizer, SX) 140, wherein the IF paths as shown in FIG. 3 are associated with the RF paths with the same carrier frequency, that is, all of the IF paths 110 as shown in FIG. 3 are associated with the same synthesizer 140, and the synthesizer 140 is used to provide a frequency signal related to the carrier frequency to the corresponding mixer. Each of the IF paths 110 comprises the transimpedance amplifier 111, the low-pass filter 112 and the analog-to-digital converter 113. The low-pass filter 112 is coupled to an output of the transimpedance amplifier 111. The analog-to-digital converter 113 is coupled to an output of the low-pass filter 112. The synthesizer 140 is coupled to mixers 512 in the associated RF paths, and the synthesizer 140 is configured to provide frequency signals required for mixing.

It should be noted that FIG. 3 only illustrates the relevant structures associated with one synthesizer in the receiving module 100. In practice, the receiving module 100 may comprise multiple synthesizers, for example, different synthesizers may correspond to different carrier frequency, such as the carrier frequencies for 3G, 4G, and 5G. In the embodiment shown in FIG. 3, the synthesizer 140 is coupled to the mixers 512 in four RF paths, meaning that each of these four RF paths receives RF signals with the same carrier frequency, which can be applied in 4*4 MIMO (Multiple Input Multiple Output) scenario. Each IF path can refer to the I path or the Q path. In the embodiments of the present disclosure, the number of PDs is related to the number of synthesizers. Specifically, in a preferred embodiment of the present disclosure, the number of PDs is twice the number of synthesizers. For example, in the receiving module 100, all I paths in the multiple IF paths associated with the first synthesizer share a first PD, and all Q paths in the multiple IF paths associated with the first synthesizer share a second PD. However, the present disclosure is not limited to this. In another embodiment, the number of PDs is equal to the number of synthesizers. For example, all I paths and all Q paths in the multiple IF paths associated with the first synthesizer in the receiving module 100 can share the same PD. Similarly, if the receiving module 100 comprises a second synthesizer in addition to the first synthesizer, then correspondingly, all I paths in the multiple IF paths associated with the second synthesizer can share a third PD, and all Q paths in the multiple IF paths associated with the second synthesizer can share a fourth PD. In another embodiment, all I paths and all Q paths in the multiple IF paths associated with the second synthesizer in the receiving module 100 can share another PD.

The multiplexer 120 is coupled to the IF paths 110, specifically, the multiplexer 120 is coupled to the corresponding nodes between the TIA 111 and the LPF 112 in each of the IF paths 110. The power detector 130 is selectively coupled to the IF paths 110 through the multiplexer 120. The power detector 130 could be used to detect the signal outputted from the transimpedance amplifier 111 at each of the IF paths 110. For example, the power detector 130 is configured to detect the received signal strength (such as power or voltage) and obtain a received signal strength indicator (RSSI). That is to say, the four IF paths 110 associated with the same synthesizer 140 share the same power detector 130. Therefore, the number of the power detector(s) 130 could be reduced and the chip area could be reduced.

The power detector 130 is coupled to only one of the IF paths 110 through the multiplexer 120 at one time. For example, the power of the four IF paths 110 could be sequentially detected by the same power detector 130.

For increasing the detection efficiency, the power detector 130 is shared between multiple IF paths associated with multiple RF paths with the same carrier frequency. For example, as shown in the FIG. 3, all of the IF paths 110 selectively coupled to the power detector 130 are coupled to the RF paths which are coupled to the same synthesizer 140 with the same carrier frequency.

In one embodiment, the receiving module 100 may comprise more than one synthesizer 140. Each synthesizer 140 is coupled to some of the IF paths 110. All of the IF paths 110 are coupled to one of the synthesizers 140 with the same carrier frequency through mixers.

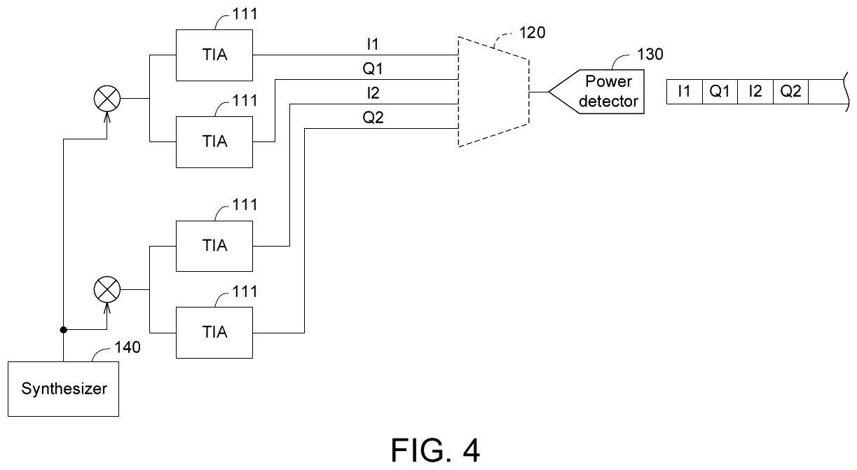

Please refer to FIG. 4, which shows the switching for the power detector 130 according to one embodiment of the present disclosure. Each IF path may comprise an In-phase path and Quadrature path. In the example of FIG. 4, a first IF path comprises I path I1 and Q path Q1, and a second IF path comprises I path I2 and Q path Q2. As shown in the FIG. 4, the power detector 130 is selectively coupled to the I path I1 and the Q path Q1 of the first IF path and also coupled to the I path I2 and the Q path Q2 through the multiplexer 120. Understandably, the two IF paths shown in FIG. 4 correspond to two RF paths coupled to the same synthesizer 140. In the embodiment, all IF paths associated with the same synthesizer can share the same PD 130, wherein the synthesizer is used for one same carrier frequency. Under this configuration, the number of PDs is the same as the number of synthesizers. For example, as shown in the FIG. 4, the power detector 130 could perform detection in order of “the I path I1, the Q path Q1, the I path I2, the Q path Q2, . . . ”. Under the sequential detection, best area saving could be achieved.

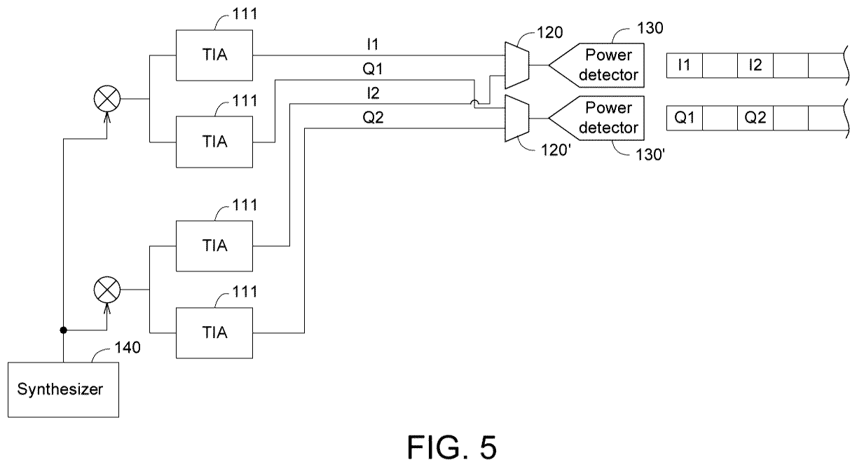

Please refer to FIG. 5, which shows the switching for the power detectors 130, 130′ according to another embodiment of the present disclosure. Each of the IF paths 110 is used for the In-phase signal of the I paths I1, I2, .... Each of the IF paths 110′ is used for the Quadrature signals of the Q paths Q1, Q2, . . . . As shown in the FIG. 5, the power detector 130 is selectively coupled to the IF paths 110 for detecting the In-phase signals of the I paths I1, I2, . . . , through the multiplexer 120 and the power detector 130′ is selectively coupled to the IF paths 110′ for detecting the Quadrature signals of the Q paths Q1, Q2, . . . , through the multiplexer 120′. As shown in the FIG. 5, the power detector 130 could perform the detection in order of “the In-phase signal of the I path I1, the In-phase signal of the I path I2, . . . ”, and the power detector 130′ could perform the detection in order of “the Quadrature signal of the Q path Q1, the Quadrature signal of the Q path Q2, . . . ”. The In-phase signals of the I paths I1, I2, . . . and the Quadrature signals of the Q paths Q1, Q2, . . . could be respectively detected at the same time to gain better accuracy.

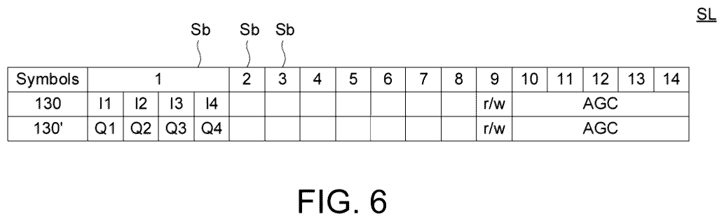

Please refer to FIG. 6, which shows the detection in one slot SL according to one embodiment of the present disclosure. In the example shown by FIG. 6, four RF paths are coupled to the synthesizer 140, all I paths I1, I2, I3, and I4 are coupled to the power detector 130, and all Q paths Q1, Q2, Q3, and Q4 are coupled to the power detector 130′. The slot SL may comprise 14 OFDM (Orthogonal Frequency Division Multiplexing) symbols. In one embodiment, the power detector 130 could perform the detection on the In-phase signal of the I path I1, the In-phase signal of the I path I2, the In-phase signal of the I path I3, and the In-phase signal of the I path I4 in one or more symbol sb, and the power detector 130′ could perform detection on the Quadrature signal of the Q path Q1, the Quadrature signal of the Q path Q2, the Quadrature signal of the Q path Q3, and the Quadrature signal of the Q path Q4 in one or more symbol sb. Then, the automatic gain control (AGC) is performed at the last five symbols sb according to detection result.

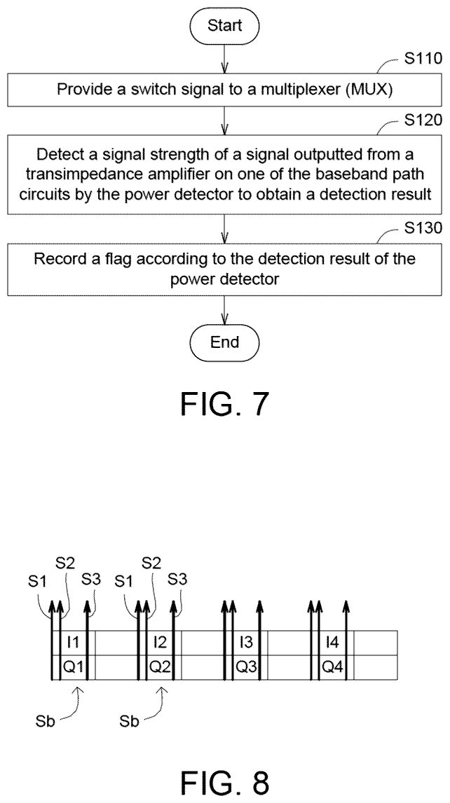

Please refer to FIGS. 7 and 8. FIG. 7 shows a flowchart of an operation method of the receiving module 100 according to one embodiment of the present disclosure, and FIG. 8 illustrates the steps in the FIG. 7 according to one embodiment of the present disclosure. The operation method of the receiving module 100 comprises steps S110 to step S130. In the step S110, as shown in the FIG. 8 and the FIG. 3, a switch signal S1 is provided to the multiplexer 120 coupled to one power detector 130. The switch signal S1 is used to control the multiplexer 120, such that the power detector 130 coupled to the multiplexer 120 is selectively coupled to the IF paths 110 through the multiplexer 120, in FIG. 3, the IF paths 110 are associated with the same synthesizer. For example, all of the IF paths are I paths or all of the IF paths are Q paths.

Next, in the step S120, as shown in the FIG. 8 and the FIG. 3, the signal strength (such as power) of the signal outputted from the transimpedance amplifier 111 on one of the IF paths 110 is detected by the power detector 130 to obtain a detection result S2 indicating the signal strength at the corresponding node.

Then, in the step S130, as shown in the FIG. 8 and the FIG. 3, a flag S3 is recorded according to the detection result S2 of the power detector 130. For example, the flag S3 is used to indicate whether the detection result S2 exceeds the corresponding limit level LT2 (or the two corresponding upper and lower thresholds). In the embodiment, the flag S3 can be used to automatic gain control (AGC), for example, to control the gain of the corresponding RF path (such as LNA 511), in particular, for example, if the flag S3 indicates that the detection result S2 exceeds the corresponding upper threshold, it can be used to control the LNA 511 to reduce its gain, and if the flag S3 is lower than the corresponding lower threshold, it can be used to control the LNA 511 to increase its gain. As shown in the example of the FIG. 8, the switch signal S1, the detection result S2 and the flag S3 are provided in one symbol sb. In another embodiment, the switch signal S1, the detection result S2 and the flag S3 could be provided in several symbols sb in one slot SL, which may depend on specific design requirements.

Moreover, as shown in the example of the FIG. 8, several cycles of the switch signal S1, the detection result S2 and the flag S3 for different the In-phase signal of the I path I1, the In-phase signal of the I path I2, the In-phase signal of the I path I3, the In-phase signal of the I path I4 (or different the Quadrature signal of the Q path Q1, the Quadrature signal of the Q path Q2, the Quadrature signal of the Q path Q3, the Quadrature signal of the Q path Q4) could be executed in one slot SL (shown in the FIG. 6).

According to the embodiments described above, several IF paths 110 could share the same power detector 130, so the number of the power detector(s) 130 could be reduced and the chip area could be reduced.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A receiving module, comprising:
a plurality of IF paths associated with a plurality of RF paths, wherein each of the IF paths comprises:
a transimpedance amplifier (TIA); and
a low-pass filter (LPF), coupled to an output of the transimpedance amplifier;
at least one multiplexer (MUX), coupled to the IF paths; and
at least one power detector (PD), wherein one of the at least one PD is selectively coupled to at least two IF paths of the IF paths through the at least one multiplexer, to alternately detect a signal strength of a corresponding node between the TIA and the LPF in a corresponding IF path,
wherein the at least two IF paths are associated with at least two RF paths of the plurality of RF paths with the same carrier frequency.

2. The receiving module according to claim 1, further comprising:
at least one frequency synthesizer, coupled to the RF paths, wherein each of the at least one frequency synthesizer is associated with a corresponding carrier frequency.

3. The receiving module according to claim 2, wherein the number of the at least one PD is twice the number of the at least one frequency synthesizer.

4. The receiving module according to claim 2, wherein the number of the at least one PD is equal to the number of the at least one frequency synthesizer.

5. The receiving module according to claim 3, wherein all of the at least two IF paths are In-phase paths; or all of the at least two IF paths are Quadrature paths.

6. The receiving module according to claim 4, wherein each of the at least two IF paths comprises an In-phase path and a Quadrature path.

7. The receiving module according to claim 1, wherein each of the RF paths comprises:
a low noise amplifier (LNA), configured to amply a corresponding RF signal; and
a mixer, coupled to the LNA and configured to perform down-conversion on an output signal of the LNA to provide a down-converted signal to corresponding IF paths,
wherein an amplitude of the LNA in the corresponding RF path is adjusted according to a signal strength of the corresponding IF paths.

8. An operation method of a receiving module, wherein the receiving module comprises at least one power detector (PD) selectively coupled to at least two IF paths through at least one multiplexer, to alternately detect a signal strength of a corresponding node in a corresponding IF path, the at least two IF paths are associated with at least two RF paths with the same carrier frequency, and the operation method comprises:
providing a switch signal to a multiplexer (MUX);
detecting a signal strength of a signal outputted from a transimpedance amplifier on one of the at least two IF paths by the power detector to obtain a detection result; and
recording a flag according to the detection result of the power detector for use in automatic gain control.

9. The operation method according to claim 8, wherein all of the at least two IF paths are In-phase paths; or all of the at least two IF paths are Quadrature paths.

10. The operation method according to claim 8, wherein at least one frequency synthesizer is coupled to the RF paths, and each of the at least one frequency synthesizer is associated with a corresponding carrier frequency.

11. The operation method according to claim 10, wherein the number of the at least one PD is twice the number of the at least one frequency synthesizer.

12. The operation method according to claim 10, wherein the number of the at least one PD is equal to the number of the at least one frequency synthesizer.

13. The operation method according to claim 11, wherein all of the at least two IF paths are In-phase paths; or all of the at least two IF paths are Quadrature paths.

14. A user equipment comprising:
a receiving module, comprising:
a plurality of IF paths associated with a plurality of RF paths, wherein each of the IF paths comprises:
a transimpedance amplifier (TIA); and
a low-pass filter (LPF), coupled to an output of the transimpedance amplifier;
at least one multiplexer (MUX), coupled to the IF paths; and
at least one power detector (PD), wherein one of the at least one PD is selectively coupled to at least two IF paths of the IF paths through the at least one multiplexer, to alternately detect a signal strength of a corresponding node between the TIA and the LPF in a corresponding IF path,
wherein the at least two IF paths are associated with at least two RF paths of the plurality of RF paths with the same carrier frequency.

15. The user equipment according to claim 14, further comprising:
at least one frequency synthesizer, coupled to the RF paths, wherein each of the at least one frequency synthesizer is associated with a corresponding carrier frequency.

16. The user equipment according to claim 15, wherein the number of the at least one PD is twice the number of the at least one frequency synthesizer.

17. The user equipment according to claim 15, wherein the number of the at least one PD is equal to the number of the at least one frequency synthesizer.

18. The user equipment according to claim 16, wherein all of the at least two IF paths are In-phase paths; or all of the at least two IF paths are Quadrature paths.

19. The user equipment according to claim 17, wherein each of the at least two IF paths comprises an In-phase path and a Quadrature path.

20. The user equipment according to claim 14, wherein each of the RF paths comprises:
a low noise amplifier (LNA), configured to amply a corresponding RF signal; and
a mixer, coupled to the LNA and configured to perform down-conversion on an output signal of the LNA to provide a down-converted signal to corresponding IF paths,
wherein an amplitude of the LNA in the corresponding RF path is adjusted according to a signal strength of the corresponding IF paths.
